(19) United States
(12) Patent Application Publication
(10) Pub. No.: US 2026/0003688 A1
(43) Pub. Date: Jan. 1, 2026

(54) RESOURCE MANAGEMENT WITH AGGREGATED RECOMMENDATION

(71) Applicant: Intuit Inc., Mountain View, CA (US)

(72) Inventors: Xiaotang SHAO, Cupertino, CA (US); Navin Kumar JAMMULA, Dublin, CA (US); Zihan JIANG, Foster City, CA (US); Hui LUO, Fremont, CA (US); Sen LIN, Santa Clara, CA (US); Chun-Che PENG, San Diego, CA (US); Shreyas BADIGER MAHADEV, Santa Clara, CA (US); Estela RAMIREZ RAMIREZ, San Jose, CA (US); Yuxuan ZHU, Sunnyvale, CA (US)

(21) Appl. No.: 18/759,411

(22) Filed: Jun. 28, 2024

(51) Int. Cl. G06F 9/50

(52) U.S. Cl. CPC G06F 9/5027; G06F 2209/5021; G06F 2209/503

(57) ABSTRACT

Certain aspects of the disclosure pertain to resource management with aggregated recommendation. Recommendations from multiple sources are aggregated and applied to allocate resources for applications deployed in a cluster. Short-term recommenders, including vertical and horizontal pod autoscalers, monitor applications and provide real-time recommendations. Long-term recommenders analyze metrics over longer windows, such as weeks, to provide stable forecasts. Further, long-term recommenders can employ machine-machine learning to infer recommendations from historical data. A global updater aggregates recommendations from both short and long-term recommenders to produce an aggregate recommendation. A resource configuration can be generated from the aggregate recommendation and deployed to a cluster to update resource allocation.

### BACKGROUND

### Field

Aspects of the subject disclosure relate to automatically adjusting computing resources allocated to an application based on a recommendation.

### Description of Related Art

Container orchestration platforms like Kubernetes® automate containerized application deployment, scaling, and management. At the core of Kubernetes® are pods, containers, and clusters. A pod is the smallest deployable unit and encapsulates one or more containers that encapsulate application code, libraries, and dependencies. Containers within a pod share networking, storage, and other computing resources. Such a grouping simplifies management and enables related containers to be deployed and scaled together. A cluster is a collection of interconnected computing resources, known as nodes, which work together to execute containerized applications. Together, clusters, pods, and containers provide the foundation for cloud application deployment and management.

### SUMMARY

Certain aspects provide a method comprising receiving recommendations regarding resource allocation for an application in a cluster from a plurality of recommenders based on resource utilization metrics available to the plurality of recommenders, where at least one of the received recommendations comprises a long-term recommendation, aggregating the recommendations from the plurality of recommenders to produce an aggregated recommendation, determining a resource configuration based on the aggregated recommendation, and updating a current resource configuration for the application with the resource configuration.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example resource allocation system.

FIG. 2 depicts an example global updater component.

FIG. 3 depicts an example method of resource allocation.

FIG. 4 depicts an example method of determining and applying an aggregated recommendation.

FIG. 5 depicts an example processing system with which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for automatically adjusting computing resources allocated to an application deployed on a cluster based on an aggregated recommendation.

Container technologies like Docker® and orchestration platforms like Kubernetes® have emerged as popular solutions for developing and managing modern, scalable applications, given widespread adoption of microservice architectures. Kubernetes®, in particular, has seen increased utilization due to its portability and automation tools.

Kubernetes® supports automatic scaling of applications through built-in self-healing capabilities that adjust resource allocation based on demand. The Horizontal Pod Autoscaler (HPA) monitors resource metrics for pods and automatically scales the number of pod replicas up or down to ensure there are enough replicas to handle the load during spikes in traffic. The Vertical Pod Autoscaler (VPA) optimizes resources like processing power (e.g., CPU) and memory for individual containers within pods. The VPA analyzes workload characteristics and recommends dynamically increasing or decreasing pod resources. HPA and VPA provide auto-scaling at pod replica and container resource levels, allowing applications to have the proper computing power based on current usage. However, as containerized workloads dynamically adjust to varying user demands, resources need continuous optimization to avoid over- or under-provisioning.

A technical problem concerns managing resources at scale as workloads vary unpredictably over time. Pod resources (e.g., CPU, memory) and the minimum and maximum number of pods need to be configured for an application. However, such a resource configuration may need to be updated to cope with unpredictable workflows. Given the dynamic nature and volume of services, manual configuration of resources is untenable. Further, manual configuration often results in vast over-provisioning of resources to ensure adequate resources are available, which is inefficient as resources are unused or underutilized. Further, existing auto-scaling tools fall short, as they operate independently without a holistic view of long-term resource needs. For instance, existing auto-scaling tools can overcorrect for bursty input, including inconsistent traffic levels, such as a low or idle period followed by a sudden increase.

A technical solution described with respect to embodiments herein includes synthesizing recommendations from multiple sources informed by short-term signals and long-term trends. A global updater can receive recommendations from short-term recommenders, such as the HPA and VPA, and one or more long-term recommenders. The long-term recommenders can exploit machine learning models trained on historical metrics collected over extended periods (e.g., weeks) to recommend resource allocations. By analyzing fluctuations and patterns in metrics, such as processor and memory usage, a machine learning model can accurately predict resource configurations for changing workloads over time. Long-term recommenders provide a more reliable recommendation than short-term recommenders that consider a snapshot of hours. Resource allocations or configurations can be determined based on short- and long-term recommendations. Consequently, resources can be adjusted dynamically to address immediate bursts or spikes captured by short-term tools. Furthermore, long-term recommendations can provide a stable baseline for normal usage patterns. Long-term recommendations can be preferred in one embodiment except for short-term surges. Aggregating recommendations from different time windows (e.g., hours, weeks) prevents overfitting resources for certain conditions at the expense of other conditions for optimizing resources, thereby improving the robustness and reliability of resource configurations. Furthermore, the global updater can manage resource allocation centrally across hundreds of clusters, thereby avoiding inconsistencies and inefficiencies that can otherwise occur and optimizing resource usage at scale.

### Example Resource Allocation System

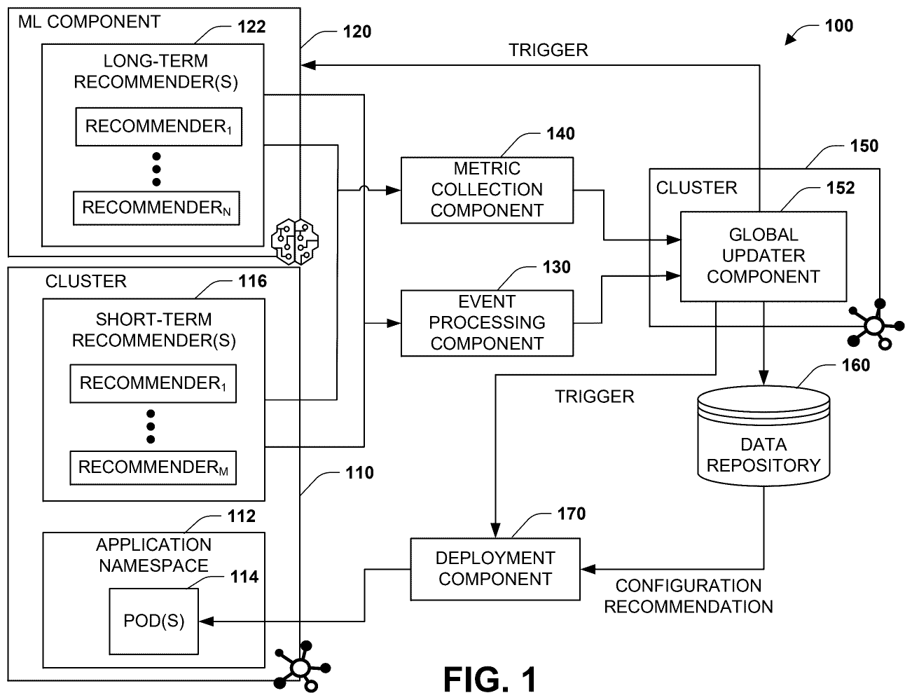

FIG. 1 depicts an example resource allocation system 100 for allocating computing resources for microservices and applications hosted by containers on clusters deployed and managed within a cloud computing environment. The example resource allocation system 100 includes a first cluster 110, a second cluster 150, and a machine learning component 120.

The first cluster 110 and the second cluster 150 can comprise a number of nodes that host containers. A node can be a virtual machine instance executing through virtualization (e.g., hypervisor) on underlying physical hardware resources (e.g., CPUs, memory, storage, network hardware) in a cloud environment. In other words, physical hardware resources can be abstracted into virtual resources spanning one or more physical hardware resources. The virtualizations enable nodes to be dynamically scaled up or down based on demand without considering physical infrastructure constraints.

The first cluster 110 comprises an application namespace 112 that includes one or more pods 114 and one or more short-term recommenders 116. The application namespace 112 provides a scope for names and allows grouping of related resources, like pods. The application namespace 112 provides a way to partition cluster resources between different users and provides an additional level of isolation and control beyond a resource name alone. A pod is a base deployment and management unit comprising one or more containers with shared storage and network resources. Pods allow containers to be deployed, managed, and scaled together as a logical unit for a containerized application or service.

The short-term recommenders 116 (RECOMMENDER1-RECOMMENDERM, where M>1) include built-in automatic scalers. For example, a short-term recommender can correspond to the Horizontal Pod Autoscaler (HPA) that monitors resource metrics for pods and automatically scales the number of pod replicas up or down to ensure there are enough replicas to handle the load during traffic spikes. In another instance, the short-term recommender can correspond to the Vertical Pod Autoscaler (VPA), which optimizes processing power and memory for individual containers to provide proper computing resources based on current usage. In accordance with one embodiment, the built-in automatic scalers can be configured to output recommendation metrics or simply recommendations rather than, or in addition to, determining and implementing recommendations. Additional short-term recommenders 116 are also possible outside the built-in automatic scalers. In one embodiment, a second HPA recommender can also be included to address a limitation of traditional HPA and update the maximum replicas as needed to address any surge in traffic. Recommendations and metrics used to determine the recommendations from the short-term recommenders 116, including HPA, VPA, and a second HPA, can be output for subsequent analysis and processing.

The second cluster 150 comprises a global updater component 152. The global updater component 152 determines a resource recommendation based on short-term and long-term metrics, recommendations, or both. In accordance with one embodiment, short-term recommenders 116 can trigger execution of the global updater component 152. In one instance, the global updater component 152 can trigger execution of one or more long-term recommendations 122 by the machine learning (ML) component 120. The global updater component 152 output is an aggregated recommendation, which may specify minimum/maximum pod resources, replica counts, and scaling metrics, among other things. The aggregated recommendation is determined by synthesizing recommendations from various sources. According to one embodiment, the maximum recommendation value for a resource can be determined from short-term and long-term recommendations, resulting in an overall short-term and long-term recommendation. The global updater component 152 can select a value from a short-term or long-term recommendation as an aggregated recommendation based on a rule. In another embodiment, the global updater component 152 can compute an average of recommendations specified by short-term recommenders 116 and long-term recommenders 122 in one embodiment. Further, a weighted average can be employed. In accordance with one embodiment, deference can be given to long-term recommendations over short-term recommendations, except for bursty traffic. Accordingly, long-term recommendations may be weighted more than short-term recommendations.

The machine learning (ML) component 120 comprises one or more long-term recommenders 122 (RECOMMENDER1-RECOMMENDERN, where N>1). In accordance with one aspect, the long-term recommenders 122 can employ machine learning to predict or infer a recommendation over an extended period. The machine learning component 120 can be configured as a network-accessible service in one embodiment. Alternatively, the ML component 120 can be executed in a different cluster. A variety of long-term recommenders are possible. For example, a pod size recommender can recommend resource sizes (e.g., CPU, memory) for application pods based on weeks of metrics rather than a day of a few hours in a day. A replica recommender can also determine the number of pod replicas to scale applications based on analyzing long-term traffic trends over an extended period. Scaling with respect to pod replicas and size refers to an ability to quickly increase or decrease the number of replicas or computing power associated with pods.

Further, a metrics recommender can be exposed as a long-term recommender that analyzes application metrics to determine an optimal scaling metric. For instance, metrics published by other sources, such as CPU, memory, and transactions per second over an extended period, can be analyzed and used to recommend a metric to scale on to enable efficient scaling in response to real demand patterns. A metric to scale on refers to a computing resource (e.g., CPUs, memory size) that can be changed or scaled up or down to impact performance. By way of example, a single application may currently scale on CPUs (e.g., number of CPUs available for use), but the metrics recommender can determine that it is best to scale on memory (e.g., memory size) as it is a better indicator of demand.

Metric collection component 140 can receive, retrieve, or otherwise acquire recommendation metrics from long-term recommenders 122 and short-term recommenders 116. The metrics collection component 140 can store metrics for later provisioning to the global updater component 152. In accordance with one embodiment, the metrics collection component 140 can correspond to Wavefront®, which is a system-as-a-service (SaaS) platform designed to monitor and analyze metric data. Of course, any messaging system or platform can be employed that is capable of transmitting metric data and recommendations to the global updater component 152.

Event processing component 130 is operable to receive, retrieve, or otherwise acquire events from the long-term recommenders 122 and short-term recommenders 116. In accordance with one embodiment, events can be generated by a recommender after a recommendation is produced. These events can notify the global updater component 152 that a recommender produced a recommendation that can be acquired using the metric collection component 140. Additionally, the events or a different event can indicate the availability of metric data associated with a recommendation. The global updater component 152 can subsequently acquire a recommendation, metric data, or both from the metric collection component 140. According to one embodiment, the event processing component 130 can correspond to Kafka®, a distributed streaming system used for stream processing of real-time data such as events at scale.

The global updater component 152 can receive, retrieve, or otherwise acquire metrics and recommendations from the metric collection component 140. In accordance with one embodiment, the global updater component 152 can utilize the metrics to generate recommendations for pod size, replica counts, and metrics for scaling. These recommendations can subsequently be aggregated with recommendations from short-term and long-term recommenders. In one instance, the global updater component 152 can prioritize long-term recommendations. However, the global updater component 152 can use short-term recommendations, for example, in a bursty traffic situation (e.g., short, sudden intervals of data), where an immediate response is required. The global updater component can produce an aggregate recommendation as output. In one embodiment, the global updater component 152 can generate and output a resource configuration from the aggregate recommendation. For example, the resource configuration can be captured by one or more manifest files discussed later concerning deployment.

By way of example, the global updater component 152 can execute an aggregation rule. The rule can involve acquiring a short-term recommendation (non-aggregated recommendation) from application production and pre-production namespaces and, for each container resource, picking the maximum of the recommendations across all namespaces. Further, the rule can involve acquiring a long-term recommendation (non-aggregated recommendation) from the application production namespace and, for each container, selecting the maximum of the recommendations across all namespaces. If “long-term recommendation>=0.85*short-term-recommendation),” the rule can be to use the long-term recommendation value; otherwise, the short-term recommendation can be used. The output is called an aggregated recommendation. Application runtime resource setting metrics, representing an application's current state, can be acquired. If the aggregated recommendation is greater than or equal to eighty-five percent of the runtime resources settings, the aggregated recommendation can be applied. Otherwise, the aggregated recommendation is discarded.

TABLE A illustrates an example scenario to aid understanding regarding generating an aggregated recommendation from short-term and long-term recommendations. The aggregation rule can be applied to generate the aggregate recommendation. More specifically, eighty-five percent of the short-term recommendation can be computed and compared with the long-term recommendation. If the long-term recommendation is greater than or equal to eighty-five percent of the short-term recommendation, the long-term recommendation is used as the aggregated recommendation. Otherwise, the short-term recommendation is selected for the aggregated recommendation. Consider the “cpuLimit” and “cpuRequest” metrics associated with the container named “istio-proxy.” The “cpuLimit” associated with the short-term recommendation is 600, and the “cpuLimit” associated with the long-term recommendation is 540. Eighty-five percent of the short-term recommendation is 510. The long-term recommendation is 540, which is greater than 510. Accordingly, 540 is selected as the aggregate recommendation value. Further examples are provided in TABLE A.

TABLE A

| | | | |
|---|---|---|---|
| containers | Short-Term | Long-Term | Aggregate |

| | | | |
|---|---|---|---|
| ContainerName | istio-proxy | istio-proxy | istio-proxy |

| | | | | | | |
|---|---|---|---|---|---|---|
| cpuLimit | 600 | m | 540 | m | 540 | m |
| cpuRequest | 500 | m | 450 | m | 450 | m |
| memoryLimit | 800 | Mi | 600 | Mi | 800 | Mi |
| memoryRequest | 700 | Mi | 500 | Mi | 700 | Mi |

| | | | |
|---|---|---|---|
| ContainerName | app | app | app |

| | | | | | | |
|---|---|---|---|---|---|---|
| cpuLimit | 1500 | m | 1350 | m | 1350 | m |
| cpuRequest | 1200 | m | 1080 | m | 1080 | m |
| memoryLimit | 3 | Gi | 2.6 | Gi | 2.6 | Gi |
| memoryRequest | 1.5 | Gi | 1.3 | Gi | 1.3 | Gi |

A recommendation produced by the global updater component 152 can be saved to data repository 160. Per one embodiment, the data repository 160 can correspond to a cloud-storage resource that stores data on servers in remote locations and secures and manages the data. For example, the data repository 160 can correspond to an S3 (Simple, Storage, Service), and the configuration recommendation can be stored in an S3 bucket.

Deployment component 170 can implement a recommendation on one or more pods 114 in the application namespace 112. The deployment component 170 can be triggered by the global updater component 152. Alternatively, the deployment component 170 can periodically check a location in the data repository 160 for a change. The deployment component 170 or an associated tool can automatically apply the recommendations on the pods 114 in the application namespace 112. In accordance with one embodiment, the global updater component 152 or a separate component can generate Kubernetes® manifest files that capture a resource configuration. A manifest file (e.g., JSON, YAML) declaratively describes the desired state of an object within a cluster and provides a way to manage objects. The manifest files can define resource availability and limits for pods and can be saved to the data repository 160 by the global updater component 152. Subsequently, the deployment component 170 can read the manifest files from the data repository 160 and synchronize the recommended configurations to the deployments in the target namespace 112. For example, the deployment component 170 can employ a Kubernetes® tool such as Argo CD® to apply a manifest and deploy the aggregate configuration as a result.

Below is an example of a K8S manifest associated with the aggregated recommendation of Table A.

```
apiVersion: apps/v1
kind: Deployment
metadata:
  name: example-deployment-manifest
spec:
  template:
      metadata:
      annotations:
          sidecar.istio.io/inject: “true”
          sidecar.istio.io/proxyCPU: 450m
          sidecar.istio.io/proxyCPULimit: 540m
          sidecar.istio.io/proxyMemory: 700Mi
          sidecar.istio.io/proxyMemoryLimit: 800Mi
      spec:
        containers:
        - name: app
          resources:
            limits:
                cpu: 1350m
                memory: 2.6Gi
            requests:
                cpu: 1080m
                memory: 1.3Gi
```

The example resource allocation system 100 illustrates resource allocation with respect to a containerized service or application on a single cluster to facilitate clarity and understanding. However, the global updater component 152 can manage resources with respect to many services and clusters. Accordingly, the global updater component 152 can include custom metrics that capture the number of services managed by the global updater component 152 and each service's horizontal/vertical automatic management status.

The example resource allocation system 100 and the global updater component 152, in particular, provide several benefits over traditional approaches. First, the global updater component 152 is in a separate cluster to avoid inconsistencies and inefficiencies that can occur when each service or cluster individually configures resources and optimizes resource usage at scale, across hundreds of clusters, for example. Second, recommendations are aggregated from multiple sources, including short-term and long-term recommenders to make more informed decisions than using a single recommender, which leads to more accurate resource allocation. Accurate resource allocation can pertain to right-sizing resource allocation for an application, avoiding under-provisioning and over-provisioning resources. Further, long-term recommenders can employ a trained machine learning model to detect long-term trends in resource utilization and traffic patterns beyond short-term recommender capabilities. For example, long-term recommenders can employ a regression model (e.g., linear, random forest, gradient boosting) or neural hierarchical interpolation for time series forecasting (NhiTS) trained over the past thirty days of application resource usage data. Additionally, automating the recommendation process through the global updater component 152 relieves the burden on service teams to monitor metrics and decide on resource changes manually. Furthermore, automating the recommendation process enables optimal resource allocation and avoids improper sizing of resources associated with manual intervention, such as over-provisioning or under-provisioning resources.

### Example Global Updater

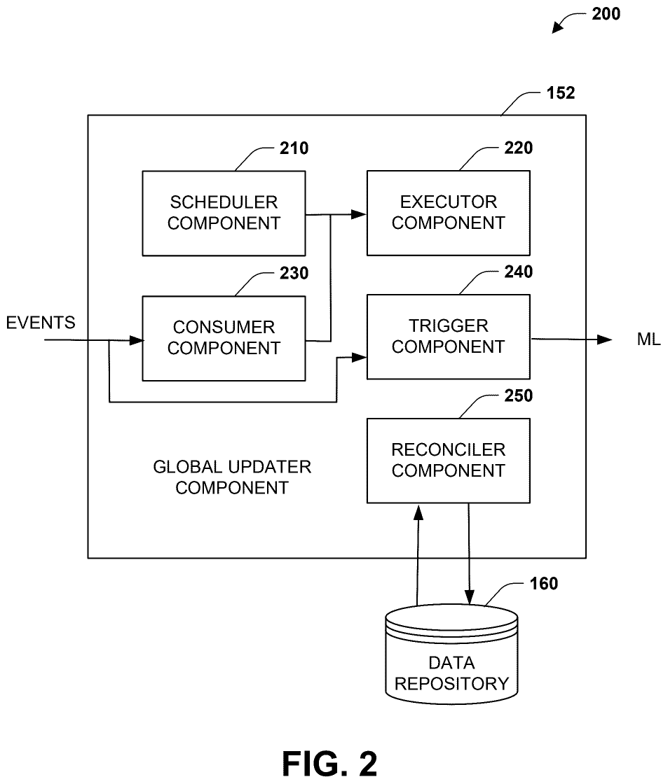

Turning attention to FIG. 2, an example global updater component 152 is illustrated in further detail. According to one embodiment, the example global updater component 152 can implement a controller pattern that comprises multiple controllers. A controller pattern is a design pattern that provides guidelines, or a pattern, for building consistent and reliable software, similar to how a blueprint is a pattern for an architect and a recipe is a pattern for a chef. The controller pattern employs controllers or control loops to regulate the state of a system. A controller can track the state of a resource and is responsible for adjusting a current state to a desired state. For example, the controllers can be Kubernetes controllers that actively monitor and maintain a set of Kubernetes resources in a desired state. Like following a recipe, a controller follows rules to keep clusters running smoothly by monitoring the current state of a resource (e.g., pod) and adjusting the resource to match a desired state as specified in a resource's configuration. The example global updater component 152 can comprise a plurality of components, including scheduler 210, executor component 220, consumer component 230, trigger component 240, and reconciler component 250.

The scheduler component 210 is operable to fetch information about applicable microservices or applications (e.g., workspace, cluster, namespace) and create custom resource (CR) definitions that capture the information. For example, scheduler component 210 can fetch such information utilizing one or more application programming interfaces (APIs) associated with an information knowledge systems management (IKSM). The scheduler component 210 is further operable to periodically (e.g., every 24 hours) call the executor component 220 and update the custom resource with recommendations. In one instance, this can be a failsafe process in case an event does not trigger the executor component 220.

The executor component 220 is operable to listen for events, such as new recommendation metrics, and trigger a workflow to apply the recommendations. The executor component 220 orchestrates the application or deployment of aggregate recommendation metrics. More specifically, the executor component 220 can receive and aggregate metrics or recommendations from numerous long-term and short-term recommenders to generate a recommendation. In one embodiment, a custom resource can be updated with the recommendation. Subsequently, the custom resource can be utilized by the reconciler component 240 to update the data repository 160, which can trigger the deployment of the recommendation.

The consumer component 230 is operable to monitor objects of a certain type and trigger a particular action. For example, the consumer component 230 can receive events associated with various recommenders or the like (e.g., vertical pod autoscaler (VPA), horizontal pod autoscaler (HPA), pod size recommender (PSR), replica size recommender (RSR)) and send a request (e.g., HTTP request) to the executor component 220 to service the events. However, in one instance, a past event can be compared with a new event, and if there is no difference, the executor component need not be called. Per one embodiment, the events can be sent on a message bus (e.g., Kafka®). The consumer component 230 then acts as an interface between the message bus or platform and the global updater component 152.

The trigger component 230 is operable to monitor an event bus and trigger execution of the machine learning component 120 and corresponding long-term recommenders 122 of FIG. 1. For instance, the trigger component 230 can receive new metrics published on the event bus. In response, trigger component 230 can initiate execution of the machine learning component 120 to generate new recommendations based on new data.

The reconciler component 240 is operable to monitor the current or actual state and reconcile differences between the actual and desired states. More specifically, the reconciler component 240 can monitor recommendations generated by the global updater component 152 for resources (e.g., pod sizes, replica counts). The reconciler component 240 can compare the current deployment state with the desired state captured by one or more recommendations. If the current deployment state diverges from the desired state, the reconciler component 240 saves any changes or recommendations to the data repository. For instance, if the reconciler component 240 detects a difference between the latest aggregated recommendation and the current runtime deployment state (e.g., k8s manifest), a new deployment state can be generated based on the latest recommendation. In one instance, the reconciler component 240 can retrieve the current deployment state from data repository 160 of FIG. 1 and subsequently update the data repository 160 with a desired deployment state, given a new recommendation. The deployment component 170 of FIG. 1 can subsequently receive the recommendation from the data repository 160 and implement the recommendation to achieve the desired state.

### Example Methods of Resource Management

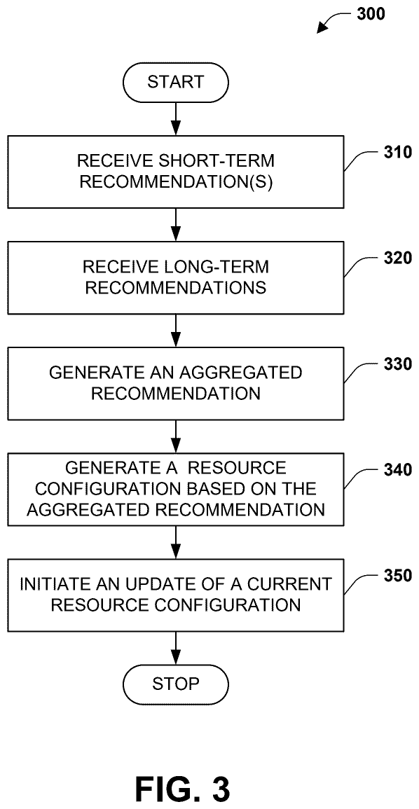

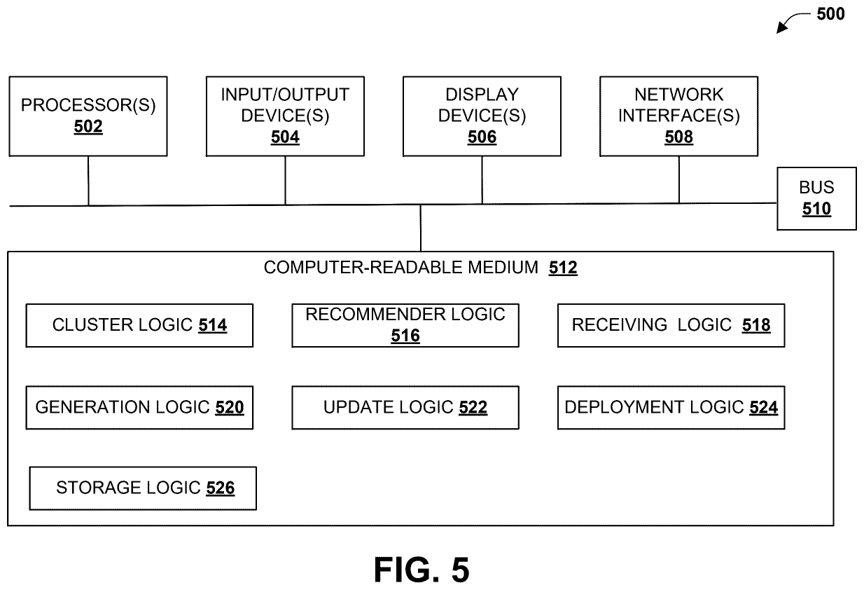

FIG. 3 depicts an example method 300 of resource management with aggregated recommendation. In one aspect, method 300 can be implemented by an example resource allocation system 100 of FIG. 1 and the processing apparatus of FIG. 5.

The method 300 starts at block 310, with receiving one or more short-term recommendations. Short-term recommendations are generated based on metrics collected over an abbreviated time, such as a day or a few hours. Short-term recommendations can include traditional vertical and horizontal pod autoscalers (e.g., VPA, HPA), among others, that analyze metrics for a single day. Short-term recommendations focus on immediate needs and may not be as accurate as long-term recommendations since they operate on limited historical data. In accordance with one embodiment, the recommendations and, optionally, the metrics utilized to make the recommendation, can communicated through a cloud-hosted monitoring service or platform such as Wavefront®.

The method 300 then proceeds to block 320, with receiving one or more long-term recommendations. The long-term recommendations analyze metrics over an extended period, such as a week or longer, rather than a single day, which provides a stable forecast for resource needs in the future. Long-term recommenders can employ machine learning in one embodiment to facilitate inference of a recommendation. A variety of long-term recommenders are possible. For example, a pod size recommender can be employed that recommends resource sizes (e.g., CPU, memory) of application pods based on weeks of metrics. A replica recommender can also be employed that determines a number of pod replicas to scale applications based on analyzing long-term traffic trends over an extended period.

The method 300 then proceeds to block 330, generating an aggregated recommendation. The aggregated recommendation can be generated based on one or more received short-term and long-term recommendations. In one instance, the aggregated recommendation can include one or more short-term recommendation metrics and one or more long-term recommendation metrics based on an aggregation rule or the like. In one instance, the aggregated recommendation can be an average of short-term and long-term recommendations. In another instance, long-term recommendations can be given priority over short-term recommendations by weighting the long-term recommendations more, thereby generating a weighted average. However, short-term recommendations can be given priority for bursty traffic. In one embodiment, the long-term recommendations can be utilized to generate a range, for example, of pod replicas, within which the short-term recommendations can operate.

The method 300 then proceeds to block 340, generating a resource configuration based on the aggregated recommendation. A resource configuration comprises specific settings for resource allocation that implement a recommendation. The aggregated recommendation can be specified at a higher level, such as a number of replica pods or a number of processors per pod. The resource configuration is generated from one or more recommendations. In accordance with one aspect, the resource configuration can be embodied as a manifest.

The method 300 then proceeds to block 350, with initiating an update of a current resource configuration with the generated resource configuration. In accordance with one embodiment, the resource configurations can first be compared to ensure they are different. As a result, a determination can be made that an update is needed. If needed, the update can be initiated in several ways. For example, the update can be initiated by saving a new resource configuration to data repository 160 of FIG. 1, which can be monitored by the deployment component 170 of FIG. 1 for new configurations and subsequently deploy the resource configurations.

Aggregating recommendations from multiple sources, including short-term and long-term recommenders, enables informed and reliable recommendation generation. Exploiting real-time through short-term recommenders and historical data through long-term recommenders provides a comprehensive view of resource needs, enabling optimal or right-sized resource recommendation generation and improving overall system performance and efficiency. Further, automating the decision process reduces the burden on service teams and ensures resources are correctly sized without human error or oversight.

Note that FIG. 3 is just one example of a method, and other methods including fewer, additional, or alternative steps are possible consistent with this disclosure.

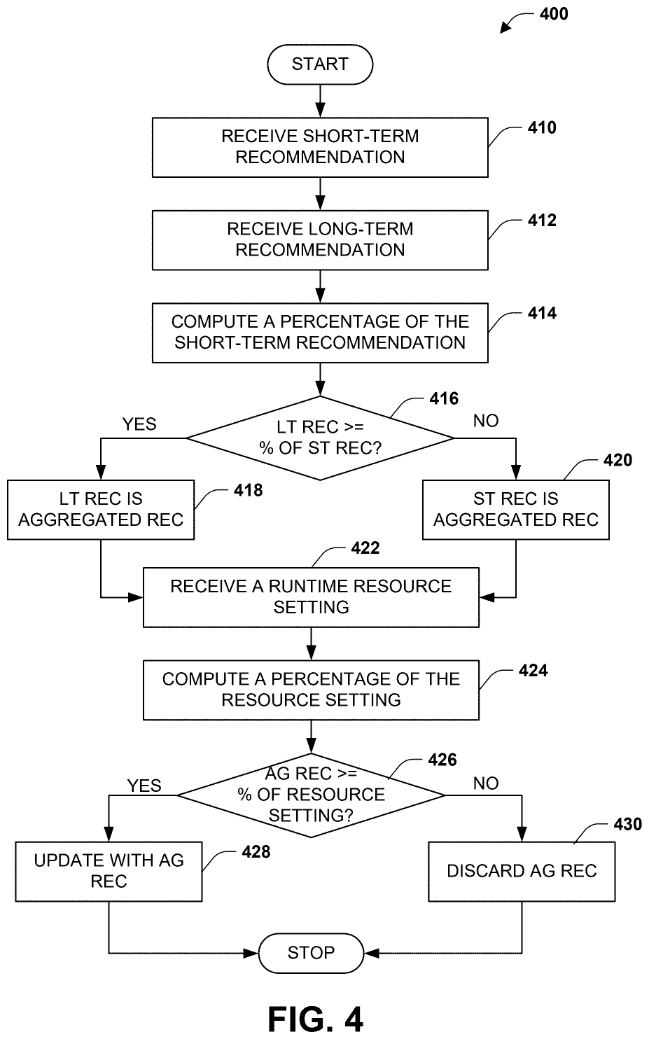

FIG. 4 illustrates an example method 400 of aggregated recommendation generation and application for resource management. The method 400 can be performed by the global updater component 152 of FIGS. 1 and 2. The method 400 pertains to a single metric to facilitate clarity and understanding and is not meant to be limited to one metric but rather is applicable to numerous metrics.

The method 400 begins at block 410 with receiving a short-term recommendation or recommendation metric. A short-term recommendation is generated based on data collected over an abbreviated time, such as a day, and can include a recommendation from traditional vertical and horizontal pod autoscalers (e.g., VPA, HPA), among others, which analyze metrics for a single day. A short-term recommendations focuses on immediate needs and may not be as accurate as long-term recommendations since they operate on limited historical data.

The method 400 proceeds to block 412 with receiving a long-term recommendation. A long-term recommendation is generated based on data collected over an extended period, such as a week or longer, rather than a single day, which provides a stable forecast for resource needs in the future. A variety of long-term recommenders are possible, including a pod size recommender that recommends resource sizes (e.g., CPU, memory) of application pods based on weeks of metrics and a replica recommender that determines a number of pod replicas to scale applications based on analyzing long-term traffic trends over an extended period. Per one aspect, the long-term recommendation can pertain to the same feature or metric as the short-term recommendation, such as a processor limit or memory limit for a container.

The method 400 next proceeds to block 414 with computing a percentage of the short-term recommendation. The percentage is configurable. In accordance with one embodiment, the percentage is eighty-five percent. Suppose the recommendation has a metric value of 600 units. Eighty-five percent of 600 units can be computed to be 510 units (e.g., 0.85×600).

The method 400 continues to block 416 with a decision regarding whether or not the long-term recommendation (LT REC) is greater than or equal to the percentage of the short-term recommendation (ST REC) computed at block 414. If the long-term recommendation is greater than or equal to the percentage of the short-term recommendation (“YES”), the method proceeds to block 418, where the long-term recommendation is designated as the aggregated recommendation. If the long-term recommendation is not greater than or equal to the percentage of the short-term recommendation (“NO”), the method continues to block 420, where the short-term recommendation is designated as the aggregated recommendation. For example, if the long-term recommendation metric value is 540 units and the percentage of the short-term recommendation metric value is 510 units, the long-term recommendation can be designated as the aggregated recommendation.

The method 400 proceeds to block 422 with receiving a runtime resource setting. The runtime resource setting is not a recommendation but rather the current setting value for the corresponding metric or feature, such as processor limit or memory limit.

The method 400 continues to block 424 with computing a percentage of the resource setting. The percentage can be configurable. In accordance with one embodiment, the percentage can be eighty-five percent. Accordingly, if the current setting for processing limit, for example, is 500 units, eighty-five percent can be computed to be 425 units (e.g., 0.85×500).

The method 400 next proceeds to block 426, with determining whether the aggregated recommendation (AG REC) is greater than or equal to the percentage of the resource setting value. If the aggregated recommendation is greater than or equal to the percentage of the resource setting value (“YES”), an update is triggered with the aggregated recommendation in block 428. If the aggregated recommendation is not greater than or equal to the percentage of the resource setting value (“NO”), the aggregated recommendation is discarded in block 430. For example, if the aggregated recommendation is 540 units and the percentage of the resource setting is 425 units. An update can be triggered to change the resource setting value from 500 to the aggregated recommendation of 540.

Note that FIG. 4 is just one example of a method, and other methods including fewer, additional, or alternative steps are possible consistent with this disclosure.

### Example Processing System for Resource Allocation

FIG. 5 depicts an example processing system 500 operable to perform various aspects described herein, including, for example, method 300 and method 400 as described above with respect to FIGS. 3 and 4.

Processing system 500 is generally an example of an electronic device operable to execute computer-executable instructions, such as those derived from compiled computer code, including, without limitation, personal computers, tablet computers, servers, smartphones, smart devices, wearable devices, augmented or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and one or more memories or computer-readable mediums 512. In the depicted example, the aforementioned components are coupled by one or more buses 510, which may generally be configured for data exchange amongst the components. Bus(es) 510 may be representative of multiple buses, while only one is depicted for simplicity.

Processor(s) 502 are generally operable to retrieve and execute instructions stored in one or more memories, including local memory (ies)/computer-readable medium(s) 512, as well as remote memories and data stores. Similarly, processor(s) 502 are operable to store application data residing in local memory (ies)/computer-readable medium(s) 512, as well as remote memories and data stores. More generally, bus(es) 510 is operable to transmit programming instructions and application data among the processor(s) 502, display device(s) 506, network interface(s) 508, and/or memory (ies)/computer-readable medium(s) 512. In certain embodiments, processor(s) 502 are representative of one or more central processing units (CPUs), graphics processing units (GPUs), tensor processing units (TPUs), accelerators, and other general or special-purpose processing devices.

Input/output device(s) 504 may include any device, mechanism, system, interactive display, and/or other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any device operable to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, and/or extended reality devices. In various embodiments, display device(s) 506 may be operable to display a graphical user interface.

Network interface(s) 508 provide processing system 500 with access to external networks and, thereby, to external processing systems. Network interface(s) 508 can generally be any hardware and/or software capable of transmitting and/or receiving data via a wired or wireless network connection. Accordingly, the network interface(s) 508 can include a communication transceiver for sending and/or receiving any wired and/or wireless communication.

Memory (ies) computer-readable medium(s) 512 may include a volatile memory, such as a random access memory (RAM), or a nonvolatile memory, such as nonvolatile random access memory (NVRAM), or the like. In this example, memory (ies)/computer-readable medium(s) 512 includes cluster logic 514, recommender logic 516, receiving logic 518, generation logic 520, update logic 522, deployment logic 524, and storage logic 526.

In certain embodiments, the cluster logic 514 is operable to manage and orchestrate clusters and components thereof, including application namespace 112 and pods 114 of FIG. 1. The cluster logic 514 can operate with respect to clusters 110 and 150 of FIG. 1.

In certain embodiments, the recommender logic 516 can be executed to generate a recommendation regarding resource allocation. The recommender logic 516 can be integrated within short-term recommenders 119 and long-term recommenders 122 of FIG. 1.

In certain embodiments, the receiving logic 518 can be performed to receive, retrieve, or otherwise acquire recommendations, metrics, and events associated with recommendations. The receiving logic can be performed by the metric collection component 140 of FIG. 1, the event processing component 130 of FIG. 1, or both.

In some embodiments, the generation logic 520 is configured to generate an aggregated recommendation, resource configuration corresponding to the aggregated recommendation, or both. The global updater component 152 of FIGS. 1 and 2 can perform the generation logic 520.

In accordance with certain embodiments, the update logic 522 can trigger deployment of a new resource configuration. The global updater component 152 of FIGS. 1 and 2 and the executor component 220 of FIG. 2 can perform the update logic 522.

In certain embodiments, the deployment logic 524 can deploy a resource configuration with respect to a cluster, namespace, and pods. The deployment component 170 of FIG. 1 can perform the deployment logic 524.

In some embodiments, the storage logic 524 can enable saving, updating, and retrieving recommendations or resource configurations. The data repository 160 of FIGS. 1 and 2 can perform the storage logic 526.

Note that FIG. 4 is just one example of a processing system consistent with aspects described herein, and other processing systems having additional, alternative, or fewer components are possible consistent with this disclosure.

### Example Clauses

Implementation examples are described in the following numbered clauses:
Clause 1: A method comprising receiving recommendations regarding resource allocation for an application in a cluster from a plurality of recommenders based on resource utilization metrics available to the plurality of recommenders, wherein at least one of the received recommendations comprises a long-term recommendation, aggregating the recommendations from the plurality of recommenders to produce aggregate recommendations, determining a resource configuration based on the aggregated recommendations, and updating a current resource configuration for the application with the resource configuration.
Clause 2: The method of Clause 1, wherein receiving the recommendations comprises receiving a short-term recommendation based on one or more real-time resource utilization metrics, and the long-term recommendation is based on one or more historical resource utilization metrics measured over a configured period.
Clause 3: The method of Clauses 1-2, wherein aggregating the recommendations further comprises prioritizing the long-term recommendation over the short-term recommendation absent a short-term surge in metric values.
Clause 4: The method of Clauses 1-3, wherein the short-term recommendation is received from a vertical pod autoscaler operable to recommend resource allocation for a pod, and the long-term recommendation is received from a pod size recommender operable to execute a machine learning model trained to predict resource allocation for the pod.
Clause 5: The method of Clauses 1-4, further comprising updating, by the horizontal pod autoscaler recommender, a maximum number of replicas for the application to address a surge in traffic.
Clause 6: The method of Clauses 1-5, further comprising updating, by the horizontal pod autoscaler recommender, a maximum number of replicas for the application to address a surge in traffic.
Clause 7: The method of Clauses 1-6, wherein one of the plurality of recommenders is a horizontal pod target metrics recommender operable to execute a machine learning model trained to recommend one or more metrics to scale on, and the one or more metrics pertain to one or more of processing power, memory, or transactions per second.
Clause 8: The method of Clauses 1-7, further comprising receiving an event from one or more short-term recommenders and triggering execution of one or more long-term recommenders in response to the event.
Clause 9: The method of Clauses 1-8, further comprising automatically triggering execution of one or more long-term recommenders after a configured time.
Clause 10: The method of Clauses 1-9, wherein the application is deployed in one or more pods in a namespace.
Clause 11: A processing system, comprising one or more memories comprising computer-executable instructions; and one or more processors operable to execute the computer-executable instructions and cause the processing system to perform a method in accordance with any one of Clauses 1-10.
Clause 12: A processing system, comprising means for performing a method in accordance with any one of Clauses 1-10.
Clause 13: A non-transitory computer-readable medium storing program code for causing a processing system to perform the steps of any one of Clauses 1-10.
Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as one or more buses.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to, general and special-purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,” etc.), unless otherwise specifically stated, should be understood to refer to one or more elements (e.g., “one or more processors,” “one or more controllers,” “one or more memories,” etc.).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public, regardless of whether such disclosure is explicitly recited in the claims.

What is claimed is:

1. A method, comprising:
receiving recommendations regarding resource allocation for an application in a cluster from a plurality of recommenders based on resource utilization metrics available to the plurality of recommenders, wherein at least one of the received recommendations comprises a long-term recommendation;
aggregating the recommendations from the plurality of recommenders to produce an aggregated recommendation;
determining a resource configuration based on the aggregated recommendation; and
updating a current resource configuration for the application with the resource configuration.

2. The method of claim 1, wherein:
receiving the recommendations comprises receiving a short-term recommendation based on one or more real-time resource utilization metrics, and
the long-term recommendation is based on one or more historical resource utilization metrics measured over a configured period.

3. The method of claim 2, wherein aggregating the recommendations further comprises prioritizing the long-term recommendation over the short-term recommendation absent a short-term surge in metric values.

4. The method of claim 2, wherein:
the short-term recommendation is received from a vertical pod autoscaler operable to recommend resource allocation for a pod; and
the long-term recommendation is received from a pod size recommender operable to execute a machine learning model trained to predict resource allocation for the pod.

5. The method of claim 2, wherein:
the short-term recommendation is received from a horizontal pod autoscaler recommender operable to recommend a number of pod replicas, and
the long-term recommendation is received from a replicas recommender operable to execute a machine-learning model trained to recommend the number of pod replicas.

6. The method of claim 5, further comprising updating, by the horizontal pod autoscaler recommender, a maximum number of replicas for the application to address a surge in traffic.

7. The method of claim 1, wherein:
one of the plurality of recommenders is a horizontal pod target metrics recommender operable to execute a machine learning model trained to recommend one or more metrics to scale on, and
the one or more metrics pertain to one or more of processing power, memory, or transactions per second.

8. The method of claim 1, further comprising:
receiving an event from one or more short-term recommenders; and
triggering execution of one or more long-term recommenders in response to the event.

9. The method of claim 1, further comprising automatically triggering execution of one or more long-term recommenders after a configured time.

10. The method of claim 1, wherein the application is deployed in one or more pods in a namespace.

11. A processing system, comprising:
one or more processors;
one or more memories coupled to the one or more processors comprising computer-executable instructions that, when executed by the one or more processors, cause the processing system to:
receive recommendations regarding resource allocation for an application in a cluster from a plurality of recommenders based on resource utilization metrics available to the plurality of recommenders, wherein at least one of the received recommendations comprises a long-term recommendation;
aggregate the recommendations from the plurality of recommenders to produce an aggregated recommendation;
determine a resource configuration based on the aggregated recommendation; and
update a current resource configuration for the application with the resource configuration.

12. The processing system of claim 11, wherein:
receive the recommendations comprises receiving a short-term recommendation based on one or more real-time resource utilization metrics, and
the long-term recommendation is based on one or more historical resource utilization metrics measured over a configured period.

13. The processing system of claim 12, wherein aggregate the recommendations further comprises prioritizing the long-term recommendation over the short-term recommendation absent a short-term surge in metric values.

14. The processing system of claim 12, wherein:
the short-term recommendation is received from a vertical pod autoscaler operable to recommend resource allocation for a pod, and
the long-term recommendation is received from a pod size recommender operable to execute a machine learning model trained to predict resource allocation for the pod.

15. The processing system of claim 12, wherein:
the short-term recommendation is received from a horizontal pod autoscaler recommender operable to recommend a number of pod replicas, and
the long-term recommendation is received from a replicas recommender operable to execute a machine-learning model trained to recommend the number of pod replicas.

16. The processing system of claim 15, further comprising updating, by the horizontal pod autoscaler recommender, a maximum number of replicas for the application to address a surge in traffic.

17. The processing system of claim 11, wherein:
one of the plurality of recommenders is a horizontal pod target metrics recommender operable to execute a machine learning model trained to recommend one or more metrics to scale on; and
the one or more metrics pertain to one or more of processing power, memory, or transactions per second.

18. The processing system of claim 11, wherein the instructions further cause the processing system to:
receive an event from one or more short-term recommenders; and
trigger execution of one or more long-term recommenders in response to the event.

19. A global update method, comprising:
receiving recommendations regarding resource allocation for an application in one or more pods in a namespace of a cluster from a plurality of recommenders based on resource utilization metrics available to the plurality of recommenders, wherein recommendations comprise a short-term recommendation based on one or more real-time resource utilization metrics and a long-term recommendation based on one or more historical resource utilization metrics measured over a configured period;
aggregating the recommendations from the plurality of recommenders to produce an aggregated recommendation;
determining a resource configuration based on the aggregated recommendation; and
updating a current resource configuration for the application with the resource configuration.

20. The method of claim 19, wherein:
the short-term recommendation is received from a vertical pod autoscaler operable to recommend resource allocation for a pod, and
the long-term recommendation is received from a pod size recommender operable to execute a machine learning model trained to predict resource allocation for the pod.
